(19) United States
(12) Patent Application Publication
(10) Pub. No.: US 2005/0096923 A1
(43) Pub. Date: May 5, 2005

(54) System to facilitate the recycling of paper materials

(76) Inventor: Barbara A. Graham, Ruidoso, NM (US)

Correspondence Address: RODEY, DICKASON, SLOAN, AKIN & ROBB, PA, P.O. BOX 1888, ALBUQUERQUE, NM, 87103, US

(21) Appl. No.: 10/697,071

(22) Filed: Oct. 29, 2003

(51) Int. Cl. G06F 17/60

(52) U.S. Cl. 705/1

(57) ABSTRACT

The system of the present invention facilitates the recycling of paper materials. Essentially, the invention consists of a pre-paid postage mailing label, addressed to a recycling or de-inking facility, which is removeably attached or covered on a paper based communication. After the paper based communication has been used for its intended purpose, the consumer or recipient of that communication will affix or uncover the pre-paid postage mailing label, and will deposit the communication in a suitable mail depository. From the depository, it will be delivered to the recycling or de-inking facility.

### FIELD OF THE INVENTION

The present invention relates to the recycling of materials. More specifically, the invention relates to facilitating the recycling of paper based products.

### BACKGROUND OF THE INVENTION

Magazines, newspapers, and advertisements printed on paper are prevalent means of communication in today's society. According to the Paper Project (a project of Co-op America) currently, approximately 15 billion magazines are printed every year, not to mention multiple other forms of paper based communications. Altogether, these paper materials currently require production which is in excess of 2.2 million tons of paper every year. Notwithstanding the temporary usefulness each magazine, newspaper or advertisement serves, as most of these materials are only referenced for a short period of time (90% of magazines are discarded within a year of publication), and in spite of the fact that facilities are established for the recycling of most of these paper products, only 20% of the magazines are recycled with equally as low percentages for the other printed communications. The balance of the discarded magazines and paper products are deposited into landfills. This use of the landfills is detrimental not only because of the sheer amount of space occupied by these recyclable materials, but also because of the contamination that results from a decomposition of the paper material. According to the Conservatree Organization, inks contain multiple heavy metals such as lead, arsenic, cadmium, zinc, manganese, mercury, potassium, copper, chromium and nickel. Because these materials are not biodegradable, decomposition of the paper allows these pollutants to collect and establish concentration levels which are harmful to the environment (e.g. migration into ground water supplies).

Discarded paper not only occupies valuable landfill volume with the potential of dangerous pollution into residential water supplies, but also necessitates the destruction of countless natural resources. The magazine industry alone uses the equivalent of 35 million trees every year. This deforestation leads to soil degradation and natural habitat destruction. Further, if the use of paper behaves according to historical trends, the consumption of paper products will be doubled by the year 2010. The process by which trees are converted into paper can also cause dangerous pollutants. For instance, the pulp of a tree must be bleached, which results in the production of both dioxin and furan byproducts. Properly treating these pollutants is an expensive and time consuming process.

The need for the increased recycling of paper products is evident. While this need has been clear for years, the inconvenience of the current methods to facilitate this recycling has impeded any widespread adoption of any effective recycling procedure.

The main method by which recycling of these products has been manifested in society is through the use of curb side pickup and recycling center drop off methods. Multiple research studies of recycling behavior in these drop-off and curbside programs for the recycling of magazines has been conducted and a synthesis of these studies shows that participants found these types of recycling activities inconvenient. In these programs, participants are normally required to bundle, label and separate the recyclable materials and have these bundles prepared for a periodic pick-up or deliver these bundles to recycling drop off facilities. The common difficulties reported in the study were: lack of time, lack of space, pest concerns (namely rats infesting stored paper products), messiness, large and obtrusive collection bins or tubs and too few drop-off sites. All of this results in an ineffective method of facilitating recycling. Furthermore, these types of programs require significant infrastructure in that these materials must be picked up and/or transported to appropriate recycling facilities. Finally, based in part on the significant investment required to carry out such programs, many municipalities and most rural areas do not even have the opportunity to participate in such recycling efforts.

Therefore, what is needed is a simple method for recycling these paper based materials which is widely available and independent of geographic location. What is further needed is a method for recycling paper based materials which can cause minimal inconvenience or expense to average consumers.

### OBJECTS OF THE INVENTION

It is one object of the present invention to provide for a system for facilitating the recycling of paper based materials which is free to consumers or recipients of these materials.

It is a further object of the present invention to provide for a system for facilitating the recycling of paper based materials that can be used by any consumer or recipient of paper based products.

It is still a further object of the present invention to provide for a system for facilitating the recycling of paper based materials which utilizes existing infrastructure to deliver these materials to recycling facilities.

It is a still a further object of the present invention to provide for a system for facilitating the recycling of paper based materials that uses common mail carriers (e.g. U.S. Postal Service, FedEx) to deliver recyclable materials to a recycling facility.

It is still a further object of the present invention to provide for a system for facilitating the recycling of paper based materials that provides the mechanism for delivering the paper based materials with the materials themselves.

It is still a further object of the present invention to provide for a system which allows for each unit of paper based material to be delivered to a recycling facility without the requirement of bundling or separating.

### SUMMARY OF THE INVENTION

The present invention provides for a system for the facilitation of the recycling of paper based products. The system functions on the very basic theory that when minimal action is required by consumers or recipients of paper based printed communications in order to recycle these materials, a larger percentage of these materials will be recycled. Upon this theoretical foundation, the system will function by providing to consumers or recipients of paper based printed communications (e.g. magazines, newspapers, advertisements, catalogues etc.) (hereafter collectively referred to as “communications”), a mailing label which can be affixed to that communication. The mailing label will be addressed to a recycling facility or a de-inking facility which can accommodate the recycling of that paper based printed communication. Once a consumer or recipient of the communication has no further use for a communication, that consumer or recipient will simply mail the communication, using the mailing label, to an appropriate recycling or de-inking facility. The mailing label will denote postage paid status or some other method of paying for the mailing of the communication, thus the consumer or recipient of the communication only has to deposit the communication bearing the mailing label into a suitable mail depository.

Based on the simplicity and ease by which these communications can be sent to an appropriate recycling facility, this method will be much more effective than the previous methods of recycling, where a consumer is required to bundle, store and present these recyclable products either at designated times (e.g. once a week at a curb side pick-up) or has to deliver the materials to recycling drop off areas.

### BRIEF DESCRIPTION OF THE DRAWINGS

FIG. 1 illustrates one embodiment of the present invention.

FIG. 2 illustrates an alternate embodiment of the present invention.

FIG. 3 is a flow chart of the various stages of the recycling facilitation system of the present invention.

### DESCRIPTION OF THE PREFERRED EMBODIMENT

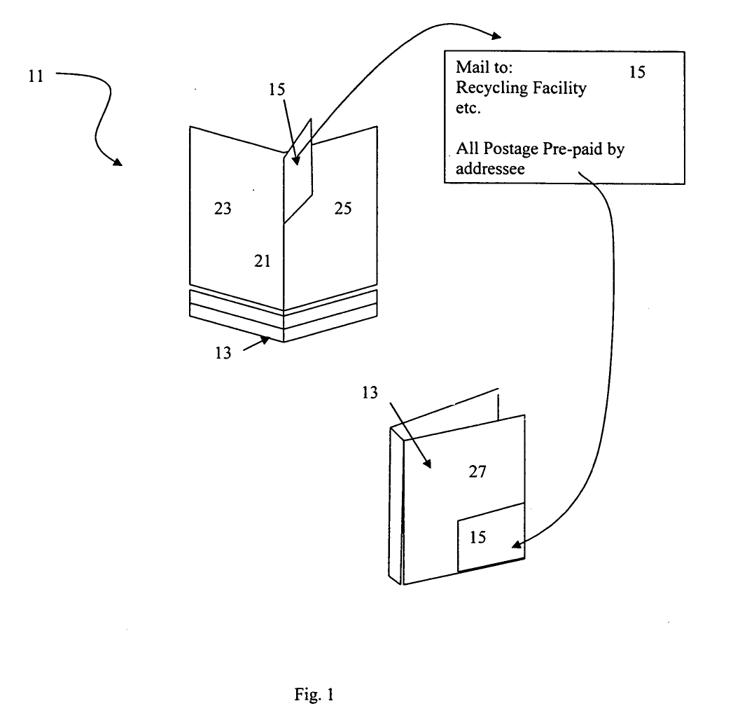

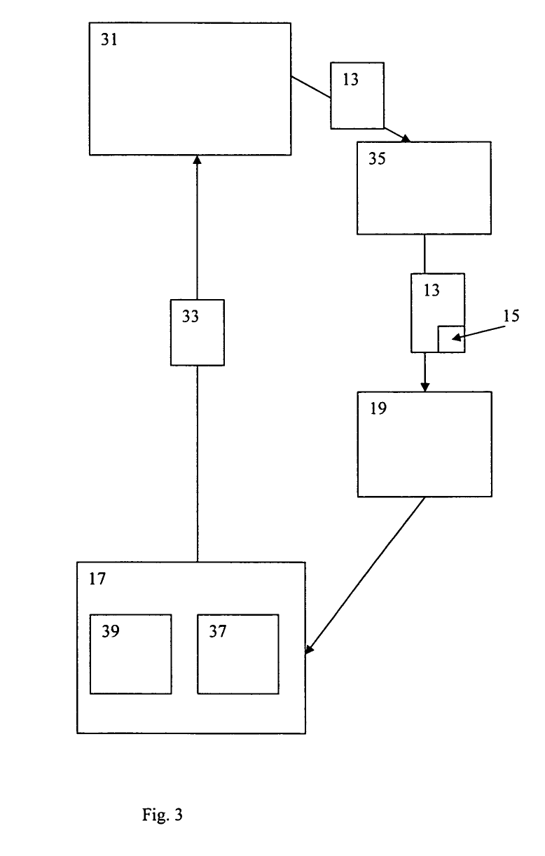

FIG. 1 illustrates the basic components of one embodiment of the system to facilitate the recycling of paper materials (“system 11”). The essential elements of system 11 are communication 13, prepaid mailing label 15 addressed to recycling facility 17 (shown in FIG. 3), and mail depository 19 (shown in FIG. 3). Recycling facility 17 can either take the form of an actual paper recycling facility or can take the form of a de-inking facility, which is necessary to recycle some materials. Further, recycling facility 17 can be chosen based on the geographic position of the consumer.

In operation with reference to FIG. 1, a consumer or recipient (not shown) will either receive or buy communication 13. Communication 13 can take the form of any communication that is printed on recyclable paper based materials (e.g. magazines, newspapers, catalogues, menus, books, paper based packaging, folders or advertisements). The method by which the consumer or recipient receives communication 13 is similarly as varied. Thus: the consumer or recipient can gain possession of communication 13 either through purchasing communication 13 from a vendor (e.g. a book store) as could be the case of a magazine or newspaper; or can receive communication 13 through the mail, as could the case of a magazine, newspaper, catalogue or advertisement; or can receive communication 13 by door to door courier such as could the case in a newspaper. Further, communication 13 could be any communication used in a business, such as a menu, teaching materials, or any other business related printed communication. The present invention will function for any communication 13 as long as a mailing label 15 addressed to a recycling facility 17 is provided with the communication. Regardless of the method by which communication 13 is conveyed to consumer or recipient, system 11 will function the same.

Accompanying communication 13 will be prepaid mailing label 15. The manner in which mailing label 15 will accompany communication 13 will depend on the type of communication (e.g., magazine or advertisement) and the method of distributing communication 13 to a consumer (e.g., through the mail or through a vendor). In one embodiment, as shown in FIG. 1 where communication 13 takes the form of a multi-page communication, mailing label 15 will be removeably attached to the interior 21 of communication 13. For instance, mailing label 15 could be removeably inserted between two pages, such as first page 23 and second page 25. In this embodiment, it does not matter whether the communication is mailed to the consumer or the consumer purchases communication 13 from a vendor or store. Thus, when the consumer (not shown) is finished using communication 13, that consumer will simply detach prepaid mailing label 15 from interior 21 of communication 13, and affix prepaid mailing label 15 to the outside cover 27 of communication 13. Communication 13 is then ready to be mailed.

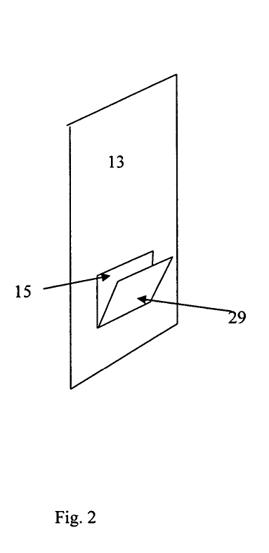

As shown with reference to FIG. 2, when communication 13 is an advertisement or other one page communication, and is mailed to the consumer, the prepaid mailing label 15 must be obscured so that communication 13 does not bypass the consumer and proceed directly to recycling location 17. In this embodiment, mailing label 15 is obscured by a covering 29. Covering 29 (which could contain the address of the recipient or end user) could then be removed when the consumer is prepared to mail communication 13 to recycling location 17.

In still yet another embodiment (not shown), mailing label 15 is affixed to communication 13 before communication 13 is even delivered to the recipient. This embodiment, however, is only possible when the method of distributing communication 13 to consumers or recipients does not involve the use of the mail.

In all of the above examples, prepaid mailing label 15 has the appropriate amount of prepaid postage. As the invention is not limited to use of the U.S. Postal Service, the term “mail” includes courier services (e.g., UPS or FedEx) and the term “postage” means the fee charged by the courier.

FIG. 3 illustrates the flow diagram for communication 13 from the time it is released from a publisher 31 until a recycled product 33 is returned to publisher 31. Once recipient 35 has used communication 13 for its intended purpose, recipient 35 places prepaid mailing label 15 on the outside cover 27(as shown in the embodiment of FIG. 1) (or in the case of the embodiment of FIG. 2, recipient 35 removes covering 29) and will mail communication 13 by depositing it in any type of mail depository 19. Mail depository 19 can be any type of commonly used mail depository such as a United States Post Office mail box, a mail box at a personal residence, or any depository for courier services such as, but not limited to, UPS or Federal Express. Communication 13 will then be delivered to recycling facility 17. Recycling facility 17 may take the form of at least one facility, which may include, for example, an ink separation facility 37 and an actual paper recycling facility 39. In many instances, paper recycling facility 39 may take the form of a paper manufacturer or may be a solitary entity. Once communication 13 has been successfully recycled by recycling facility 17, the end result will be recycled product 33, which can be delivered to publisher 31 for use to make successive iterations of communication 13.

Whereas the drawings and accompanying description have shown and described the preferred embodiments, it should be apparent to those skilled in the art that various changes may be made in the form of the invention without affecting the scope thereof.

1. A method for facilitating the recycling of printed communications including the steps of:
a. distributing said printed communications to at least one recipient;
b. providing, with each distributed copy of said printed communications, a mailing label;
c. addressing said mailing labels with a recycling facility address;
d. providing adequate postage on each of said mailing labels;
e. affixing said mailing label to said printed communication.
f. depositing said printed communications with an organization designated to deliver said printed communications;
g. transferring, by said organization designated to deliver said printed communications, said printed communications to said address of said recycling facility; and
h. recycling of said printed communications by said recycling facility.

2. The method of claim 1, further including the step of selecting a recycling facility based on the geographic location of said recipient.

3. The method of claim 1, wherein said step of affixing said mailing label to said printed communication is conducted prior to said step of distributing.

4. The method of claim 1, wherein said step of affixing said mailing label to said printed communication is conducted subsequent to said step of distributing.

5. The method of claim 1, wherein said of affixing said mailing label to said printed communication is conducted before said step of distributing and further includes the step of covering said mailing label.

6. The method of claim 5, further including the step of uncovering said mailing label subsequent to said step of distributing.

7. The method of claim 1, further including the step of separating ink from the paper of said printed communications.

8. The method of claim 1, wherein said step of distributing said printed communications to said recipient includes the step of delivering said printed communications to the residence of said recipient.

9. The method of claim 1 wherein said step of distributing said printed communications to said recipient includes the step of delivering said printed communications to the business at which said recipient is employed.

10. The method of claims 1, wherein said step of distributing said printed communications to said recipient includes the step of said recipient obtaining said printed communications from an entity associated with the sale of said printed communications.
